(19) United States
(12) Patent Application Publication
(10) Pub. No.: US 2003/0016842 A1
(43) Pub. Date: Jan. 23, 2003

(54) Digital content with information of latent value to purchaser and method for making the same

(76) Inventors: Charles M. Patton, Eugene, OR (US); Poorvi L. Vora, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/911,750

(22) Filed: Jul. 23, 2001

(51) Int. Cl. H04K 1/00; G06F 17/60; H04L 9/00; G06K 9/00

(52) U.S. Cl. 382/100; 705/51

(57) ABSTRACT

Valued content in a digital form includes a digital file and a digital string that is provided by a purchaser to a provider system of the valued content. The digital string has a latent value to the purchaser, and the provider system embeds the digital string in the digital file before the valued content is conveyed to the purchaser.

### BACKGROUND OF THE INVENTION

This invention relates generally to digital information processing systems and methods that protect digital information from improper use. More particularly, the present invention relates to embedding in a digital file information that has a latent value to the purchaser.

With the advent of the Internet, digital cable television, direct broadcast satellites etc. over the past decade, we have witnessed a virtual explosion in the use and dissemination of digital content such as, audio, video, software, documents, images, and other digital content. In the past, especially with music and videos, the systems used analog technology, which when copied produced a product of lesser quality than the original. Two commonly understood examples are the video cassette recorder (VCR) and cassette tape recorder, where each successive copy of a copy results in a degradation in quality which at some point results in images and sounds of extremely poor quality. The same has been true for books, images, and other documents where each successive photocopy of a photocopy results in degradation of the image quality.

Today, however, most information is at some point conveyed in a digital form. Copying of digital information, on the other hand, results in a copy that is identical to the original, i.e. the digital copy is perfect resulting in copies of copies being identical to the original information. The unlawful copier is therefore able to avoid the cost of creation, development, and the intellectual property concerns associated with patents and copyrights incurred by the legitimate producer. This results in legitimate consumers and producers suffering through increased prices, and has led to the loss of billions of dollars around the world each year, due to the unlawful copying of digital content legitimately owned by individuals and corporations.

These new digital technologies, especially the Internet, are a double-edged sword. In one respect, as the ease of distribution increases and the cost decreases these new digital technologies offer a great opportunity to reach vast markets on a worldwide scale in an economically feasible manner. But in another respect, these same technologies, in allowing a content provider to deliver on demand a “perfect” copy in digital form to a customer, enable unscrupulous customers (pirates) the ability to make and sell unlimited “perfect” copies of the content at the expense of the true owner.

This ability to easily copy information has triggered considerable effort in both industry and academics to find ways to protect digital information from unauthorized use. These efforts can be generally categorized into two broad areas, steganography and cryptography. Typically cryptographic or encryption technologies emphasize “prevention” of illicit acts from occurring by all potential parties (e.g. copying an audio CD). Whereas, steganography and in particular watermarking techniques typically provide “evidence” of an illicit act “after” it has taken place. A brief review will show that all of these systems have problems, thus the lack of an “ideal” solution in either of these two broad areas suggests the need for an alternative approach that does not rely on an “unbreakable” system for protection.

Steganography literally means, “covered writing” and is usually interpreted to mean hiding information in other information. Steganography is thus concerned with the embedding of a hidden message in some other information commonly referred to as a “cover,” in such a manner that the existence of the hidden message should be undetected. There are many different approaches, which have been explored and currently are used, such as transform domain techniques, spread spectrum techniques, distortion techniques, and statistical methods to name a few. With each method of hiding information, there is a trade off between the amount of hidden information that is embedded and the survivability or robustness of that information to remain undetected. This trade off results from the fact that both the original information and the message one wants to embed tend to have unique patterns or signatures that can be exploited. Thus, even information that is subject to quantization, filters, transformation, etc. is still detectable.

If one utilizes a steganographic system to protect digital information from unauthorized copying, the “pirate” has essentially two general approaches to try to defeat the system. Both approaches typically require detection or at least a suspicion that hidden information is present. Then the attacker either extracts and removes the information or the attacker overwrites and disables the information. Thus, the goal of a steganographic system is to avoid detection. If suspicion is raised then the goal is defeated because the detection of the hidden information is hard to find, however, it is typically not hard to be removed or it can be defeated once found. Although creative methods have been devised in the “hiding” process to reduce detection of the embedded information, equally creative analysis methods have been devised to find or detect the presence of the hidden information. This, results in a constant need for the “hiders” to keep ahead of the “finders” as computer technology rapidly advances. Further, steganographic systems are usually not robust against modification of the data nor are they robust against technical modifications that may occur during transmission and storage such as format conversion or compression.

Digital watermarking is a type of steganography commonly used for copyright protection and authentication. A generic example of a watermarked digital image is shown as output from a printer in FIG. 1. Although there are many different schemes used for watermarking typically the data, shown as a “W” in FIG. 1, that is to be hidden is either added as noise to every data element or added just to a pseudo-random subset of data elements. The hidden information (i.e. the watermark) is then embedded in the noise signal of the original, which for clarity is shown as the “W” superimposed on the picture in the second frame of FIG. 1. Finally, the watermarked image is shown in the bottom frame of FIG. 1, is invisible, and is retrieved only by extraction software.

There are many ways of classifying watermarking such as, secure vs. insecure, fragile vs. robust, or visible vs. invisible. Watermarking used for copyright protection is typically secure and robust and it may be visible or invisible. Although digital watermarking is closely related to steganography it is also distinguished in one major aspect, notably watermarks should be robust against attacks. Even if the existence of the embedded information is known, it should be hard for an attacker to destroy the embedded information without knowledge of a key. However, this also leads to a limitation in the use of digital watermarks, that is, the robustness requirements typically result in the embedding of much less information in the original “cover” information than steganographic methods. Thus, watermarking and steganography are more complementary than competitive approaches.

Although many schemes have been proposed for watermarking digital information, most if not all existing schemes are still capable of being defeated by collusion. For example, a watermark could be a visible “seal” placed over an image to identify the copyright owner and might also contain the identity of the purchaser of a particular copy of the image so that it is traceable back to the specific version of the original from which it was created. The watermark should be hard to remove without destroying the digital content. Thus, the watermarked digital content is traceable back to the specific version of the original from which it was created. However, if an attacker obtains more than one copy of the digital content, possibly through collusion with another, then the attacker averages the copies to make a “pirated” copy that will contain a corrupted watermark. The average of two or more watermarks no longer contains sufficient information to be tied to either of the original watermarks and thus the ability to trace back to the originator is lost. Like steganography, no perfect method has been found for watermarking that precludes distortion. Thus, in watermarking techniques a compromise is typically made between robustness and the competing requirements such as invisibility and the amount of embedded information.

The second broad area used to protect digital information from unauthorized use is cryptography. Cryptographic systems are widely used to ensure privacy and authenticity of digital information distributed over insecure channels. Typically, in using cryptographic systems, the content provider encrypts the information resulting in information accessible only by authorized parties that either know or have the decryption key.

The use of private/public encryption keys alleviates one of the principal problems associated with widely using cryptographic systems to protect digital information from unauthorized use; namely the need for the provider and customer to exchange not only the data but also the encryption key. However, it does not alleviate the problem of an unscrupulous user from making and selling unlimited “perfect” copies of the content once decrypted. Like steganography and watermarking, many cryptographic schemes have been proposed and are used to provide various degrees of protection to digital information from unauthorized use. However, two problems have proven difficult to overcome.

The first problem involves the implementation of safeguards to prevent a user from sharing the decryption key with illegitimate users. In general a user wishing to purchase some digital information obtains the encrypted information through one of many possible distribution channels (i.e. compact disc read-only memory {CD-ROM}, Internet, etc.). The user then contacts an authorization center to legitimately obtain the decryption key to decrypt the purchased information to make it useable. The authorization center does not supply the decryption key directly since to do so allows the user to provide or even sell at a profit the decryption key to others. No matter what cryptographic system the authorization center utilizes, in all encryption cases the user, to successfully utilize the encrypted information, must have in the user's possession the decryption key. Therefore, in theory it is always possible for a sophisticated user by carefully analyzing the calculation that is performed on the user's computer to obtain the decryption key. Or by modifying the code such that some verification step is bypassed the user then defeats the system by using a “patch” to circumvent the verification step. One system which is known in the art that addresses this problem is that in which an authorization function is paired with a customer number that contains some sensitive information about the user that the user does not want to share with others. This combination of authorization function and customer number is then used by the user to create the decryption key. The content is now freely available to the user yet the user cannot authorize others without either revealing the sensitive information about the user or transmitting the decryption key, which in the known prior art is made arbitrarily long to hinder easy distribution. However, with the advent of high-speed digital networks available today, the transmission of the decryption key without the sensitive information is not that difficult even when the size of the decryption key is large (e.g. the size of the digital content like a CD). Thus, there is still a need for a method and/or system that provides a disincentive for the unauthorized transmission of decryption keys.

The second problem that also must be overcome is that regardless of what system is used to protect the unauthorized use of the decryption key there is nothing to prevent a legitimate user from copying the decrypted content and sharing that with unauthorized users. In fact, barring a tamperproof hardware decryption system, there is no solution known in the art to overcome this second problem; at some point in the process, a legitimate user must have access to the decrypted information in order to use it. As long as the user is sufficiently sophisticated to be able to capture the information then the user will be able to copy it and redistribute it.

From this brief overview, we see that these systems have problems that can result in the illicit copying and distribution of digital information. Thus content providers, whether using steganography, watermarking, or cryptography, either attempt to cripple or hinder output devices in some fashion when improperly obtained content is accessed, or the content provider attempts to mark or label the valued content with some ownership information. The owner then legally attempts to enforce his rights against those who have improperly distributed or obtained the valued content. Therefore the content provider typically makes compromises between robustness of the protection system and some other attribute either of the digital file being protected or the information being embedded. This lack of an “ideal” solution in either of the two broad areas of steganography and cryptography suggests the need for an alternative approach that does not rely on an “unbreakable” system for protection but rather applies a different approach to those that are currently used. Thus a method and/or system that provides a incentive for the user not to disseminate either an encryption key or the clear digital content would be an advance in the art.

### SUMMARY OF THE INVENTION

Valued content in a digital form includes a digital file and a digital string that is provided by a purchaser to a provider system of the valued content. The digital string has a latent value to the purchaser, and the provider system embeds the digital string in the digital file before the valued content is conveyed to the purchaser.

### BRIEF DESCRIPTION OF THE DRAWINGS

FIG. 1 is a generalized example, depicting a digital image as output from a printer, of prior art showing a watermarking technique;

FIG. 2 is a block diagram of a valued content according to an embodiment of this invention;

FIG. 3a is a block diagram of a valued content according to an alternate embodiment of this invention;

FIG. 3b is a block diagram of a recovery scheme according to the embodiment of this invention shown in FIG. 3b;

FIG. 4 is a block diagram of a valued content according to an alternate embodiment of this invention;

FIG. 5 is a block diagram of a valued content according to an alternate embodiment of this invention;

FIG. 6a is a digitized image according to an embodiment of this invention;

FIG. 6b is an enlarged view of a portion of the digitized image shown in FIG. 6a according to an embodiment of this invention;

FIG. 7 is a block diagram of a digital content processing system according to an alternate embodiment of this invention;

FIG. 8 is a flow diagram of a method for protecting digital content according to an embodiment of this invention

FIG. 9 is a flow diagram of a method for protecting digital content according to an alternate embodiment of this invention.

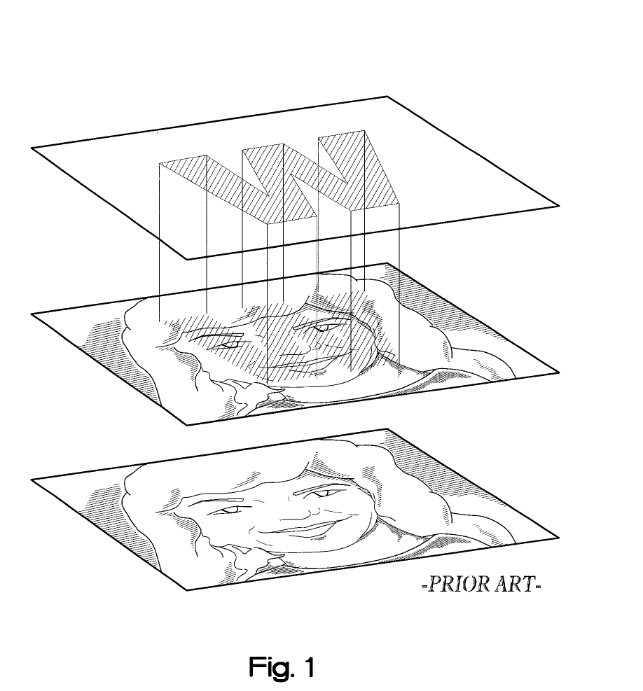

### DETAILED DESCRIPTION OF A PREFERRED EMBODIMENT

In many instances content providers attempt to cripple or hinder output devices such as DVD players (commonly referred to as either digital video disc or digital versatile disc players), printers, digital audio tape players etc. in some fashion when improperly obtained (i.e. pirated) content is accessed. In other instances, the content providers attempt to mark or label the valued content with some ownership information. When marked pirated content is accessed, the mark provides a means for the owner to legally attempt to enforce his rights against those who have improperly distributed or obtained the valued content.

A feature of the present invention, unlike the prior techniques used by the owner to actively protect his rights includes the embedding of information, which has a latent value to the purchaser, in the digital file before that file is used by the purchaser. In this manner, the very ubiquity of pirating is an enforcement method by tying together the property rights of the content provider and the purchaser. In combining the interests of providers and purchasers by embedding information that the purchaser is unlikely to want to have distributed, the purchaser is converted into a guardian of the valued content. Further, by embedding this information multiple times the incentive to the purchaser is increased because the purchaser can never be certain that all of the embedded versions have been found or are known. Thus, potential pirates are changed into enforcers. Another feature of the present invention is the ability to incorporate the embedding of information of latent value to the purchaser into existing protection systems as well as future systems.

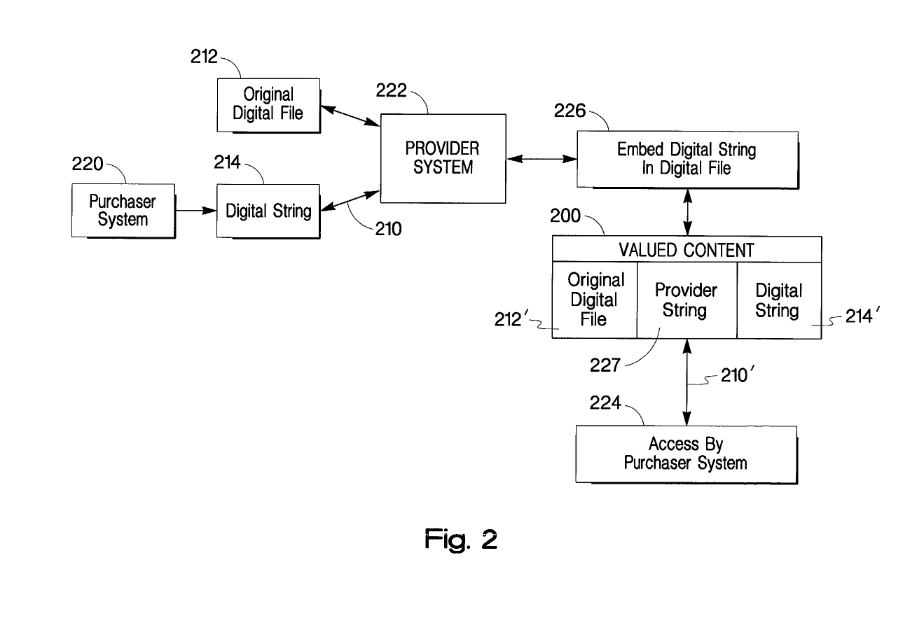

The present invention advantageously uses information obtained from each purchaser that has a latent value to the purchaser to embed in the digital content before the purchaser has access to the digital content. Referring to FIG. 2, an embodiment of the valued content 200 of the present invention in a simplified block diagram is shown. In this embodiment, a purchaser who wishes to purchase some valued content 200 in a digital form transmits a digital string 214 via a communication channel 210 to the provider system 222 using purchaser system 220. The original digital file 212 can be of any nature such as a digitized image, a text document, video images such as a movie, digitized audio such as a song, software, or other digital file. Preferably, the communication channel 210 is a digital network such as what is commonly referred to as the Internet. Other communication channels such as wireless communication, wireline telephone, digital cable television, as well as other point-to-point, point-to-multipoint, and broadcast communications methods can also be used. Preferably, the digital string 214 is a binary representation of human perceptible characters or sound suitable for transmission over the Internet or other electronic channels.

The digital string 214 can be of any nature such as a number, text, or an image. In addition, the digital string 214 contains information that has a latent value to the purchaser. Preferably, the digital string 214 contains information that places the purchaser at increased financial risk when known by another. Both the adequacy and sufficiency of the information provided by the purchaser via the purchaser system 220 is typically made by the provider system 222, however, negotiation between the purchaser and a provider directly or between the purchaser system 220 and the provider system 222 may occur. Information that may be used or requested by the provider system 222 are credit card numbers and expiration dates, social security number, date of birth, bank account number, personal identification numbers (PIN), address, or phone number are just a few examples and are not meant to be exhaustive nor limit the scope of the present invention.

Once the appropriate information is obtained that is suitable to create a sufficient incentive for the purchaser not to share the valued content 200 with others, the valued content 200 is made accessible to the purchaser and/or the purchaser system 220. Thus, once the provider system 222 has obtained the required information from the purchaser or purchaser system 220, the provider system 222 uses various digital watermarking techniques, steganographic techniques, encryption/decryption schemes, or semantic embedding techniques to embed 226 the digital string 214 into an original digital file 212 to generate the valued content 200. For a more detailed description of an example of embedding hidden information in digital objects, see U.S. Pat. No. 5,530,751.

Preferably, a combination of techniques available such as digital watermarking and steganography or any of the other combinations available are used to embed the digital string 214 in the valued content 200. Those skilled in the art will appreciate that by using combinations of techniques available, the provider system 222 takes advantage of the fundamental differences between them. For example, by using both a digital watermarking technique and a steganographic system two different robustness criteria are established.

It is also advantageous to embed 226 the digital string 214 multiple times in the valued content 200. For example, the provider system 222 encrypts the digital string 214 using “m” different encryption keys and then embed 226 those “m” encrypted digital strings “n” times in the original digital file 212′. The provider system 222 then publishes via the Internet or other communication channel a subset of the “m” encryption keys to enable others who believe they have obtained an illegal copy to gain access to the sensitive information conveyed by the purchaser system 220. Further, the provider system 222 by providing various subsets of the “m” encryption keys at different times increases the incentive to the purchaser because the purchaser can never be certain all the embedded versions of the digital string 214 have been found for which keys are available.

Another feature of the present invention is that the information embedded in the valued content 200, can also include a provider string 227 which contains other information such as a finders fee in addition to the digital string 214 provided by the purchaser system 220. For example, the provider system 222 can also embed 226 a notice for a reward to any member of the public who identifies a file that has been inappropriately distributed to others, in addition to the sensitive information obtained from the purchaser or the purchaser system 220.

Access 224 to the valued content 200 by the purchaser system 220 is gained via a communication channel 210′. Depending on the particular method used to protect the valued content 200, the valued content 200 can be conveyed to the purchaser via the communication channel 210′. Preferably, communication channel 210′ is the same as communication channel 210; however, other communications channels, such as wireless communication or digital cable television can also be used. In addition, in the case where the original digital file 212 is encrypted the decryption key or some authorization code can be conveyed to the purchaser system 220 by the communication channel 210′ in which either the decryption key or the authorization code is embedded in it the digital string 214. In the latter case once the purchaser system 220 has access to the decryption key or the authorization code, the valued content 200 is then generated on the purchaser's system 220 (i.e. both the decryption of the original digital file 212′ and the embedding 226 of digital string 214′ in the original digital file 212′).

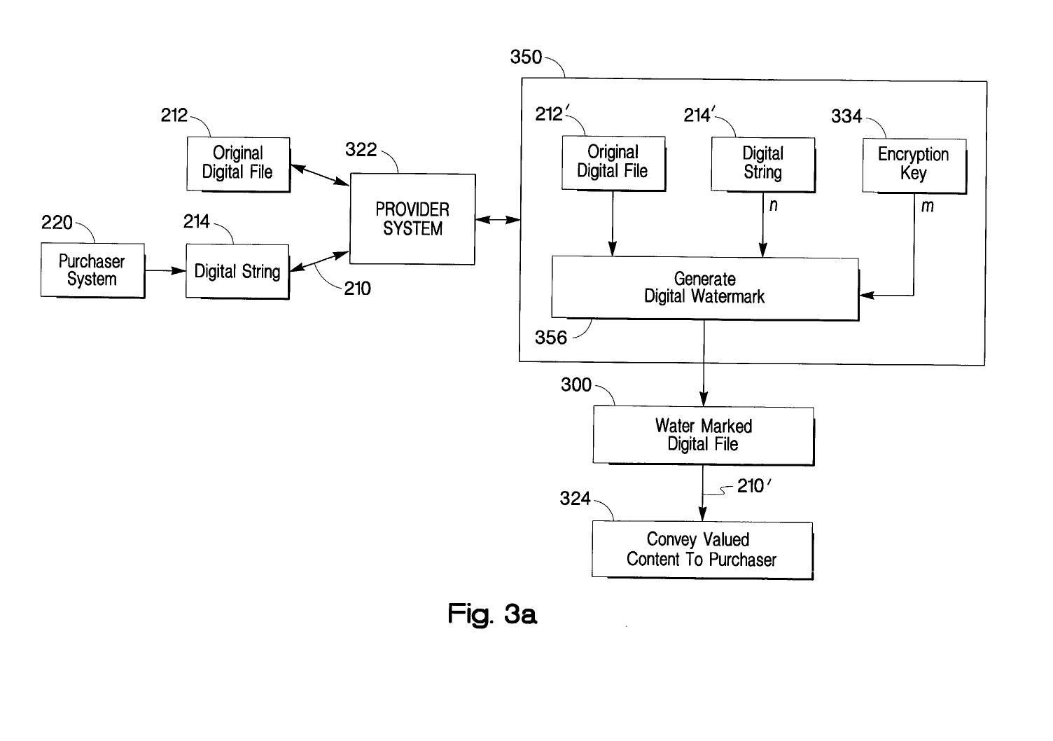

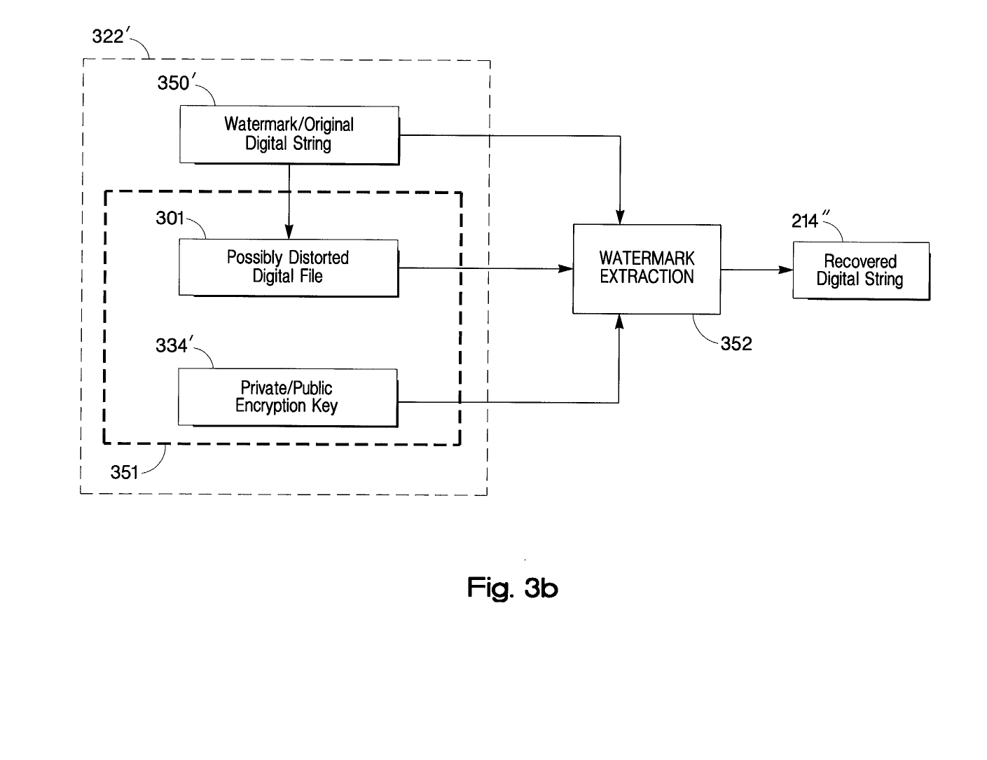

An alternate embodiment of the present invention where the provider system 322 protects the valued content 300 by using a digital watermark containing the digital string 214 is shown as a simplified block diagram in FIG. 3. In this embodiment, once the provider system 322 has obtained the digital string 214 from the purchaser system 220, the provider system 322 generates a digital watermark 350 from the information contained in the digital string 214 using a particular watermarking scheme. It is preferable that the provider system 322 utilize a watermarking technique that allows for the watermark to be retrieved regardless of the domain where it was embedded. This is important in applications such as audio and video and images requiring resilience to transcoding or change of format.

The watermarking embedding process utilizes the digital string 214′ as the watermark, original digital file 212′ as the “cover” and an optional encryption key 334 to generate an encrypted digital watermark. The encryption key 334 may or may not be used depending on the particular application. In addition, the encryption key 334 may be used in combination with some unencrypted watermarks. Preferably the encryption key 334 used is of the type generally referred to as a private/public encryption key, and a combination of several keys are utilized to embed multiple encrypted digital strings 214′. The encryption key 334 provides additional security against manipulation or erasure by unauthorized parties trying to defeat the watermark. Preferably, in this embodiment, the modifications caused by the watermark embedding process are below a perceptible threshold that includes a criterion that weighs the value of the original digital file 212′ against the loss resulting from unauthorized use. In addition, to further ensure robustness despite the small allowed changes; the information contained in the digital string 214′ preferably is redundantly distributed over many samples (bytes, pixels, features, etc.) of the original digital file 212′ shown as “n” in FIG. 3. If “m” represents the number of different encryption keys used then “m” encrypted digital strings 214′ are embedded in the original digital file 212′ “n” times. This provides a global robustness, which means that the digital watermark can be recovered from a fraction of the watermarked digital file. These principles apply to watermarking techniques for various forms of valued content such as audio, images, video, formatted text, three-dimensional models, animation parameters, and others.

The output of the watermarking technique is the valued content 300, which contains the watermarked digital file. The valued content 300 is then conveyed 324 to the purchaser system 220 via the communication channel 210′. Preferably, the communication channel 210′ is the same as the communication channel 210; however, other communications channels may also be used. Once, the purchaser or purchaser system 220 has obtained valued content 300 the purchaser has access to the digital information contained in the original digital file 212. An advantage of the present invention is that at the point the purchaser system 220 has access to the digital information the purchaser has a vested interest in ensuring that the information contained in the original digital file 212 is not distributed to other users since the valued content 300 also contains information about the purchaser, that has latent value to the purchaser.

A simplified block diagram of a watermarking recovery scheme is shown in FIG. 3b, which provides additional incentive to the purchaser not to distribute the valued content 300 to other users. The provider system 322, when the valued content 300 is conveyed 324 to the purchaser system 220 (as shown in FIG. 3a), also places in the public domain a subset of the “m” versions of the public encryption keys 334′ used and makes this known to the purchaser at the time of purchase. The provider system 322 also makes a watermark extraction process publicly available. Thus, if the purchaser then either distributes the valued content 300 directly to others or the purchaser attempts to disable the digital watermarking resulting in a possibly distorted digital file 301 and then distributes the possibly distorted digital file 301 to others, the subsequent users 351 can gain access to the very information that the purchaser wants to keep private by utilizing the public encryption key 334′ distributed by the provider system 322. The watermark extraction process 352 using the public encryption key 334′ extracts bits of information (i.e. the digital string 214″) from either the valued content 300 or the possibly distorted digital file 301. Preferably, the provider system 322 distributes the public encryption key over the Internet, however other communication channels may also be used without diminishing the utility of the present invention.

In addition, the provider system 322′ can also extract the digital string 214″ from either the valued content 300 or the possibly distorted digital file 301 by utilizing either the encryption key 334′ or the watermark/original digital string 350′. Thus, by utilizing both a combination of the private/public encryption keys 334′ and redundantly distributing the digital string 214′ over numerous samples in the valued content 300, the provider system 322 gains the advantage of providing an additional incentive to the purchaser not to unlawfully distribute valued content 300. Furthermore, by utilizing the public encryption key 334′ the provider system 322 can also maintain one or more of the redundantly embedded digital strings 214′ in a secure manner for eventual decryption (i.e. using the private encryption key 334′), identification, tracking, and enforcement of the owner's legal rights against those who have improperly distributed the valued content 300.

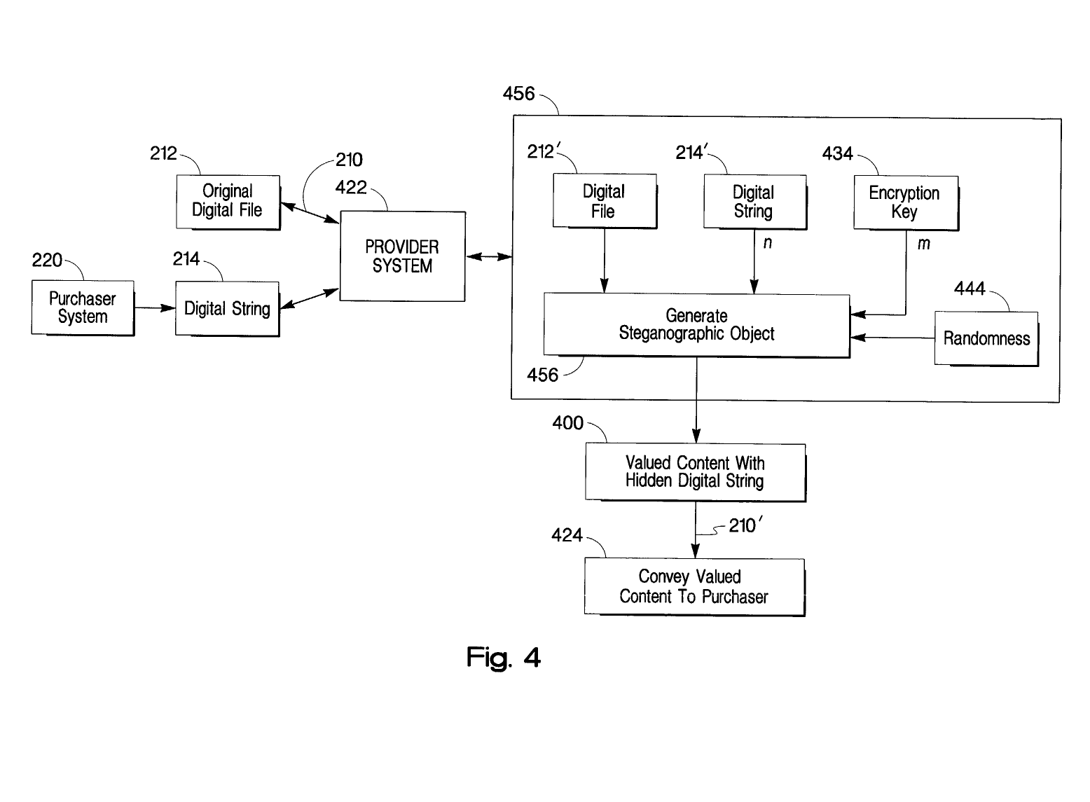

An alternate embodiment of the present invention, where the provider system 422 protects the valued content 400 by generating a steganographic object containing the digital string 214, is shown as a simplified block diagram in FIG. 4. In this embodiment, similar to that shown for watermarking in FIGS. 3a-3b, the provider system 422 generates, from the digital file 212′, the digital string 214′ and a random number generator 444, a steganographic object 456 using a particular steganographic technique. In this embodiment, it is also advantageous to use a private/public encryption key 434 and to hide the information contained in digital string 214′ multiple times denoted by “n” in FIG. 4. Preferably, the provider system 422 distributes the public encryption key over the Internet, however other communication channels may also be used without diminishing the utility of the present invention.

The valued content 400 containing the digital file with the hidden digital string preferably should not be distinguishable from the original digital file 212, either by human perception or by a computer looking for a statistical pattern. It is also preferable that the particular steganographic technique used should allow any computer readable data such as image files, digital sound, or written text etc. to be used. Those skilled in the art will readily recognize that although watermarking schemes and steganographic techniques have been described separately they can also be utilized in combination to take advantage of the fundamental differences between them. For example, by using a digital watermarking system with a public key and redundantly embedded information along with a steganographically hidden digital string, the provider system 422 can optimize the ability for others to access the purchaser's sensitive information via watermarking, as well as providing tracking and enforcement of the owner's legal rights against those who have improperly distributed the valued content 400 via the steganographic technique.

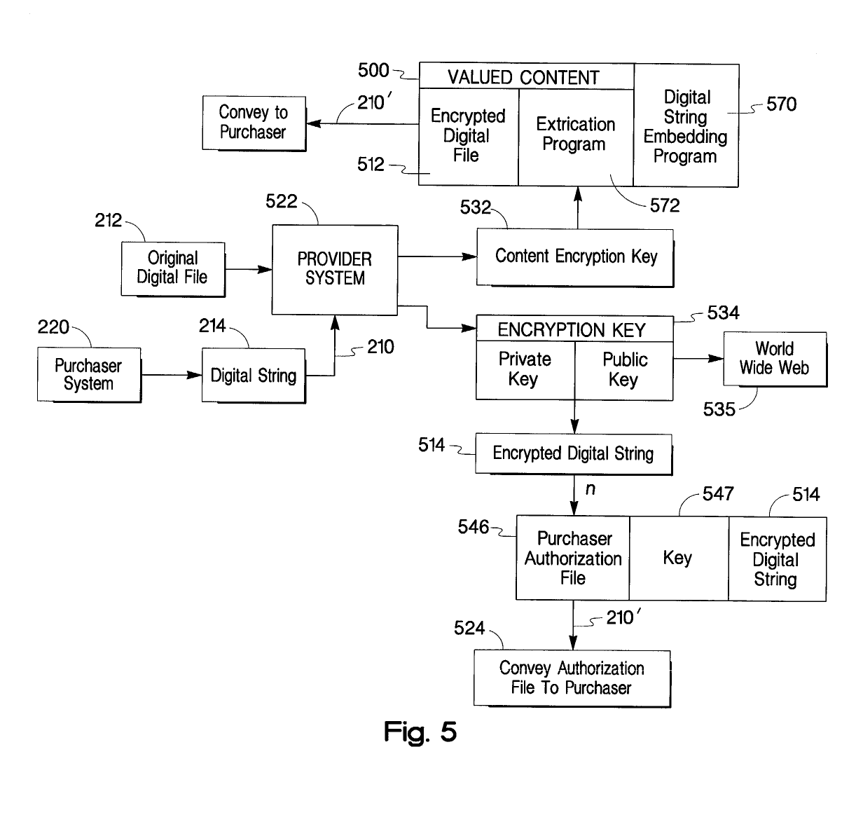

An alternate embodiment of the present invention is shown as a simplified block diagram in FIG. 5, where the provider system 522 protects the valued content 500 by using authorization file 546 containing the encrypted digital string 514 to enable decryption of the valued content 500. Similar to the other embodiments shown in FIGS. 2-4 a purchaser who wishes to purchase some valued content 500 in a digital form transmits a digital string 214 via a communication channel 210 to the provider system 522. In this embodiment, the valued content 500 is in the form of an encrypted digital file 512, that the purchaser system 220 then uses a decryption key to gain access to the valued content 500 in a useable form. One example of an encryption/decryption technique is described in U.S. Pat. No. 6,038,316. The valued content 500 also contains whatever other information is required to be stored with the content as is necessary for the various encryption/decryption schemes utilized, such as an extractor and an embedder. Preferably, the extractor is an extrication program 572 that uses the authorization file 546 to decrypt encrypted digital file 512, however other means will also work such as a hardware device. In addition, the embedder, preferably, is a digital string embedding program 570, which will be explained later.

The encrypted digital file is conveyed over communication channel 210′ and can be distributed via CD-ROM, or the Internet, but may also include other communication channels such as networks, digital cable TV, etc. This embodiment is particularly applicable to those media that makes the information available on a public basis. For example, mass mailings of CD-ROMs to potential customers whose names are selected from a target mail list.

The provider system 522 generates an encrypted digital file 512 using the content encryption key 532 to encrypt the original digital file 212. The provider system 522 also generates the encrypted digital string 514 from the digital string 214 obtained from the purchaser system 220 using the encryption key 534. The encryption key 534 is preferably a private/public encryption key pair and can be similar to the encryption keys described for watermarking and steganographic techniques as shown in FIGS. 3a and 4. In addition, the provider system 522 may either make redundant copies of the encrypted digital string 514 or, more preferably, the provider system 522 encrypts the digital string 214 using “m” different encryption keys and then embeds those “m” encrypted digital strings “n” times in the key 547. The provider system 522 generates the purchaser authorization file 546 that contains the key 547 that will enable the purchaser system 220 to utilize the valued content 500. The provider system 522 also publishes via the Internet or other communication channel a subset of the “m” encryption keys to enable others who believe they have obtained an illegal copy to gain access to the purchasers sensitive information.

The provider system 522 also gains the advantage of providing an additional incentive to the purchaser not to unlawfully distribute the purchaser authorization file 546 by utilizing both a combination of the encryption keys 534 and redundantly distributing the encrypted digital string 514 numerous times in the key 547. In addition, when the provider system 522 uses a private/public encryption key the provider system 522 by encrypting with the public key 534 can also maintain one or more of the redundantly embedded encrypted digital strings 514 in a secure manner for eventual identification, tracking, and enforcement of the owner's legal rights against those who have improperly distributed the purchaser authorization file 546. The provider system 522 also places in the public domain one or several versions of the public encryption key 534 and makes this known to the purchaser at the time of purchase. If the purchaser then distributes the purchaser authorization file 546 to others the subsequent users can gain access to the very information that the purchaser wants to keep private by utilizing the public encryption key 534 distributed by the provider system 522. The public encryption key extracts bits of information (the digital string 214) from the purchaser authorization file. Preferably, the provider system 522 distributes the public encryption key over the Internet commonly referred to as the world wide web 535, however other communication channels may also be used without diminishing the utility of the present invention.

Depending on the particular encryption/decryption scheme used, the key 547 may contain various attributes. For example, if the extrication program contains the decryption key necessary to decrypt the encrypted digital file 512 then the key 547 in addition to containing the encrypted digital string 514 will also contain an authorization code that enables the extrication program to execute the extrication function on the authorization code to generate the decryption key. Alternatively, the key 547 may contain the decryption key itself with multiple copies of the encrypted digital string 514 embedded in the decryption key. In this way, the provider system 522 advantageously solves the decryption revelation problem since the purchaser has a vested interest in ensuring that the information contained in the key 547 is not distributed to other users since the key 547 also contains information about the purchaser that has latent value to the purchaser regardless of the particular encryption/decryption scheme utilized. Preferably, the provider system 522 uses an encryption/decryption scheme that embeds multiple copies of the encrypted digital string 514 embedded in the decryption key sent to the purchaser system 220.

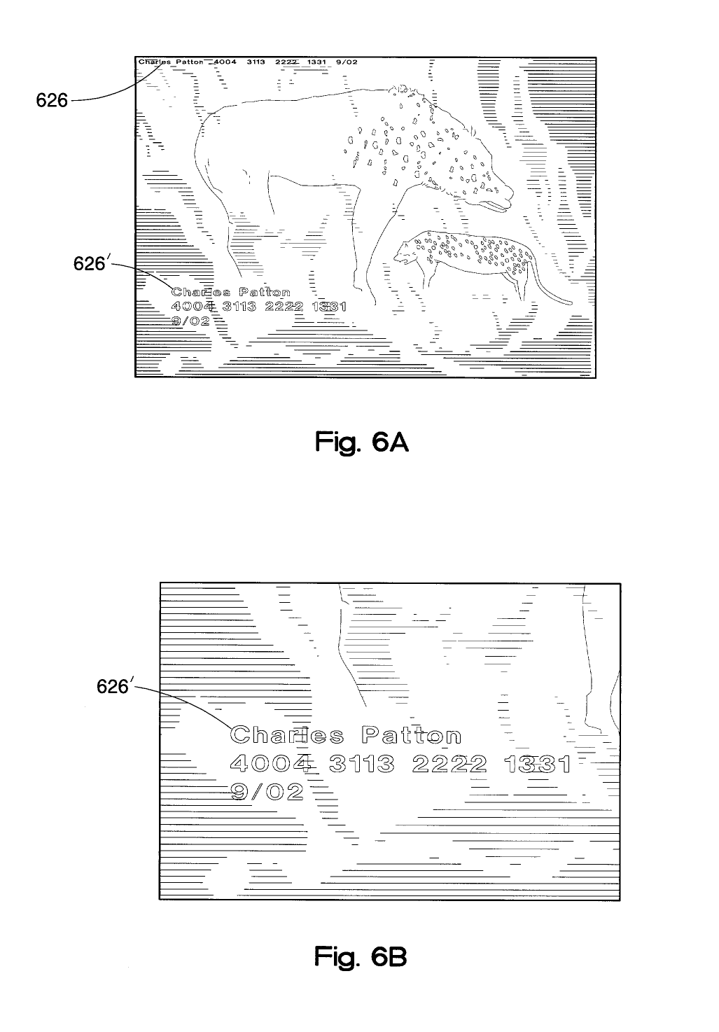

The printer output of a digitized image representing valued content to which a purchaser is interested in obtaining some particular rights is illustrated in FIG. 6a. In this example the digitized image reproduced on an inkjet printer output page is representative of the output from a digital file according to an embodiment of this invention. The image has value to the provider because of the cost incurred in obtaining the image from the previous owner or from business costs in the creation, development and handling as well as possible artistic costs associated with producing the image. The image also has value to the purchaser again for possible esthetic reasons or for use in a product being developed such a magazine article or sales brochure. In this embodiment, information that has a latent value to the purchaser is communicated to the content provider. The information has latent value to the purchaser because for purposes of this illustration it is assumed that the purchaser's name, credit card number, and expiration date are sufficient to create an incentive in the purchaser not to share the image with others. For example, the image shown in FIG. 6a could be a “proof” image used by the purchaser for layout purposes. Once the purchaser is satisfied with the layout, the purchaser then purchases the same image with the information having latent value embedded in the image such that the information is not visible to the normal eye using any of the embodiments previously described. Thus, the embedded digital string 626 as shown in FIG. 6a represents the information of latent value to the purchaser as seen in the output from the digital file. FIG. 6b is an enlarged view of a portion of the output from FIG. 6a showing the embedded digital string 626′ that has also been embedded in a different portion of the digital file.

An alternate embodiment of the present invention is where the provider system protects the valued content by using semantic embedding. In this embodiment, the provider system employs rearrangements of semantic elements of the digital file. The semantic elements are those elements that have a contextual meaning and are used to convey information, which may be additional to the content itself. An example of semantic embedding is, “One if by land. Two if by sea,” where the information represented by the arrangement of lanterns in a church scene is used to encode the route of arrival of British forces. Similarly, so-called “product placements” embed advertising information into the semantic content of a movie or television show.

This embodiment is particularly preferable when the valued content is digitized video such as a movie, television show, or digitized audio. To effect such an embedding, the content itself preferably has a multiplicity of transposable elements. These elements should be transposable in space, time, quality, and in the presence or absence of the elements. Further, these elements must be contextual to the content, however, each of the set of rearrangements of the elements should be approximately equivalent in terms of the meaning of the content to others. After the purchaser provides the digital string containing information of latent value to the provider system, the provider system encodes this information in the arrangements of the transposable elements in the content. The provider system also records the ‘key’ to the location(s) and to the deciphering of the information obtained from the purchaser for later release as described in the previous embodiments. For example, this can be as simple as providing directions on where to look for the information, or as complex as cryptographic techniques. With the advent of digital compositing, and it concomitant automation it is possible to create a new version of a film, video, song, etc. for every purchaser. By delaying the final compositing until the time of purchase, the provider system can add the information obtained from the purchaser to the configuration of, for example, the computer graphics animation. The resulting digital output can be composited with the more fixed elements of the original digital file to produce a valued content that is thus different for each purchaser. For example, a pattern of ornamentation on a magic sword could be the set of transposable elements into which the information of latent value is placed. The computer graphics embodying the sword are designed, along with the camera views of the sword, such that the computer graphics of the sword can be altered. Thus, every view of the sword throughout the movie can be automatically changed, and the resulting views composited into that copy of the film delivered to that particular purchaser. Similarly, the placement of decorative pinwheels in an otherwise insignificant background of an entire scene can be arranged as postproduction customization to encode the information obtained from the purchaser. Another example would be the placement of the seams in a stone wall can also be arranged as postproduction customization to encode the information obtained from the purchaser.

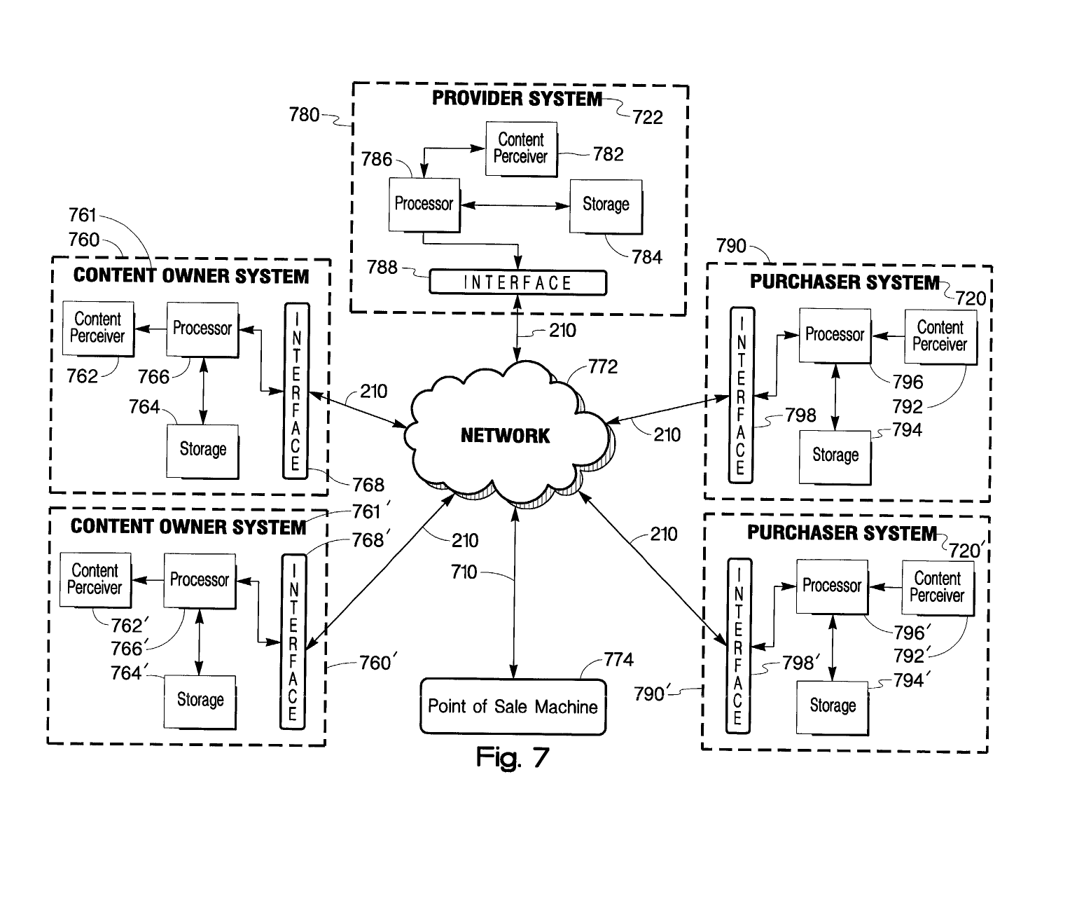

A simplified block diagram of a preferred environment for the operation of the present invention is shown in FIG. 7. The digital processing system 780 contains a processor 786, storage 784 and a content perceiver 782 that is all used by the provider system 722 for generating the various digital calculations and processing as described in the above embodiments. For example, the processor 786 embeds the digital string 214 in the original digital file 212 to generate the valued content 200 all shown in FIG. 2. A further example is the processor 786 encrypting both the original digital file 212 and the digital string 214 shown in FIG. 5. The content perceiver 782 can be a computer terminal, a printer device such as an inkjet printer, a digital camera, or audio or video device such as a digital audio tape drive system or DVD system. The content perceiver is any device necessary to perceive the original data file 212 shown in FIG. 2. Storage 784 can be processor memory, other computer memory such as a hard disk or portable memory such as a CD-ROM, DVD, DAT etc. or any appropriate combination.

The digital processing system also contains an interface 788 allowing the provider system 722 to communicate with the content owners system 761 and 761′ as well as the purchaser systems 720 and 720′ over the communication channels 210. Preferably, the communication channel 210 is a digital network 772 such as what is commonly referred to as the Internet. Other communication channels such as wireless communication, wireline telephone, digital cable television, as well as other point-to-point, point-to-multipoint, and broadcast communications methods can also be used. The communication channels 210 can also include various combinations of the above mentioned channels. For example, the provider system 722 and the content owner system 761 can communicate over a wireless communication channel and the provider system 722 and the purchaser system 220 can communicate over a wireline telephone channel.

Also shown in FIG. 7 is a digital processing system 790 that contains a processor 786, storage 794 and a content perceiver 792 that is all used by the purchaser system 220 for generating the digital string 214 and accessing the valued content 200 shown in FIG. 2. For example, the processor 796 decrypts the encrypted digital file 412 shown in FIG. 5. The content perceiver 792 is any device necessary to perceive the original data file 212 shown in FIG. 2 and may be more specialized than the content perceiver 782 used by the provider system 722. Storage 794 can be processor memory, other computer memory such as a hard disk or portable memory such as a CD-ROM, DVD, DAT etc. or any appropriate combination. The interface 798 allows the purchaser system 720 to communicate with the content owner systems 761 and 761′ as well as the provider system 722 over the communication channels 210.

Also shown in FIG. 7 is a digital processing system 760 that contains a processor 766, storage 764 and a content perceiver 762 that is all used by content owner 761 for creating or modifying the original digital file 212 shown in FIG. 2. The content perceiver 762 is any device necessary to perceive the original data file 212 shown in FIG. 2 and may be more specialized than the content perceiver 782 used by the provider system 722. Storage 764 can be processor memory, other computer memory such as a hard disk or portable memory such as a CD-ROM, DVD, DAT etc. or any appropriate combination. The interface 768 allows the content owner 761 to communicate with the purchasers 790 and 790′ as well as the provider system 722 over communication channels 210.

The point of sale machine 774 also shown in FIG. 7 provides several advantages. It is applicable when purchaser system 220 does not have either interface 798 or access to communication channel 210 but has the other equipment necessary to access valued content 100 as shown in FIG. 2. In this embodiment communication channel 710 preferably is a digital network such as what is commonly referred to as the Internet. Other communication channels such as wireless communication, wireline telephone, digital cable television, as well as other point-to-point, point-to-multipoint, and broadcast communications methods can also be used. In addition, the use of the point of sale machine 774 is also applicable where purchaser system 220 wants to purchase valued content 100 as shown in FIG. 2 in a form which is useable in a portable media format such as DVD or DAT. Further, it is also applicable when it is advantageous to the provider system 722 not to share extrication program 572 and/or digital string embedding program 570 or key 547 with purchaser system 220, as shown in FIG. 5, since in this case the purchaser obtains valued content 100 with digital string 214′ already embedded.

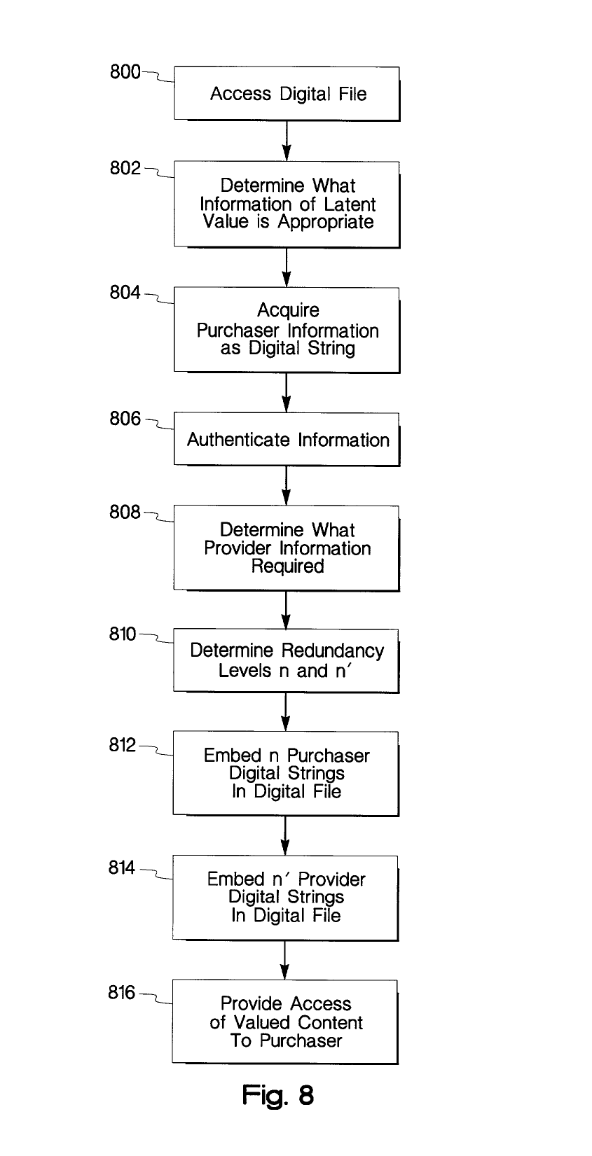

An overview of the operation of the present invention is shown in FIG. 8. In step 800, the provider system accesses the digital file. The digital file may reside on the provider's digital processing system 790 or the content owner's digital processing system 761 as shown in FIG. 7 or it may also reside on some remote processing system such as a server on the network 772 also shown in FIG. 7.

The provider system then determines what information of latent value to the purchaser is appropriate, in step 802, that is sufficient to establish an incentive in the purchaser not to distribute the digital file to others by placing the purchaser at an increased financial risk when known by another. Step 802 may be predetermined by a provider or step 802 may also involve the provider system negotiating with the purchaser directly or the purchaser system to agree on the information required. The provider system then acquires the digital string from the purchaser system over a communication channel in step 804. In step 806 the provider system authenticates the information contained in the digital string obtained from the purchaser system. The authentication step 806 can include both internal databases residing on the provider's digital processing system (790 as shown in FIG. 7) or external databases residing on a remote processing system or on a server on the network.

The provider system also determines what if any provider information should also be embedded in the digital file before conveying the digital file to the purchaser. This provider information can be, for example, a reward or finders fee that adds further protection to the provider that the purchaser will not unlawfully distribute the digital file. The provider system in step 810 determines the redundancy levels “n” and “n′” where n is the number of times the purchaser information acquired in step 804 will be embedded into the digital file accessed in step 800. The value “n′” is the number of times the provider information determined in step 808 will be embedded into the digital file accessed in step 800. In determining the value of both “n” and “n′” the provider may take into consideration the purpose and value of the digital file, the attributes of the digital file for both watermarking and the steganographic technique being utilized as well as others.

The provider system then embeds the purchaser digital string in the digital file in step 812 using one of the embodiments previously described, such as watermarking, steganographic techniques, or encryption schemes. The provider system also embeds the provider digital string, in step 814, in the digital file using one of the embodiments previously described. The method used to embed the provider digital string in step 814 can be the same or different than the method used to embed the purchaser digital string in step 812. For example, the purchaser digital string can be embedded using a watermarking technique, while the provider digital string can be steganographically embedded.

After completion of the embedding steps the provider then provides the purchaser access to the valued digital content, in step 816, containing the embedded information of latent value to the purchaser and if appropriate the embedded information from the provider. Step 816 is accomplished in numerous ways. Preferably, it involves transmitting the valued digital content over the Internet. However, it can involve sending the purchaser authorization file to the purchaser via the Internet. It may also involve providing the valued content recorded on a portable media such as a DVD, or DAT either through a point of purchase machine 774 as shown in FIG. 7 or other means.

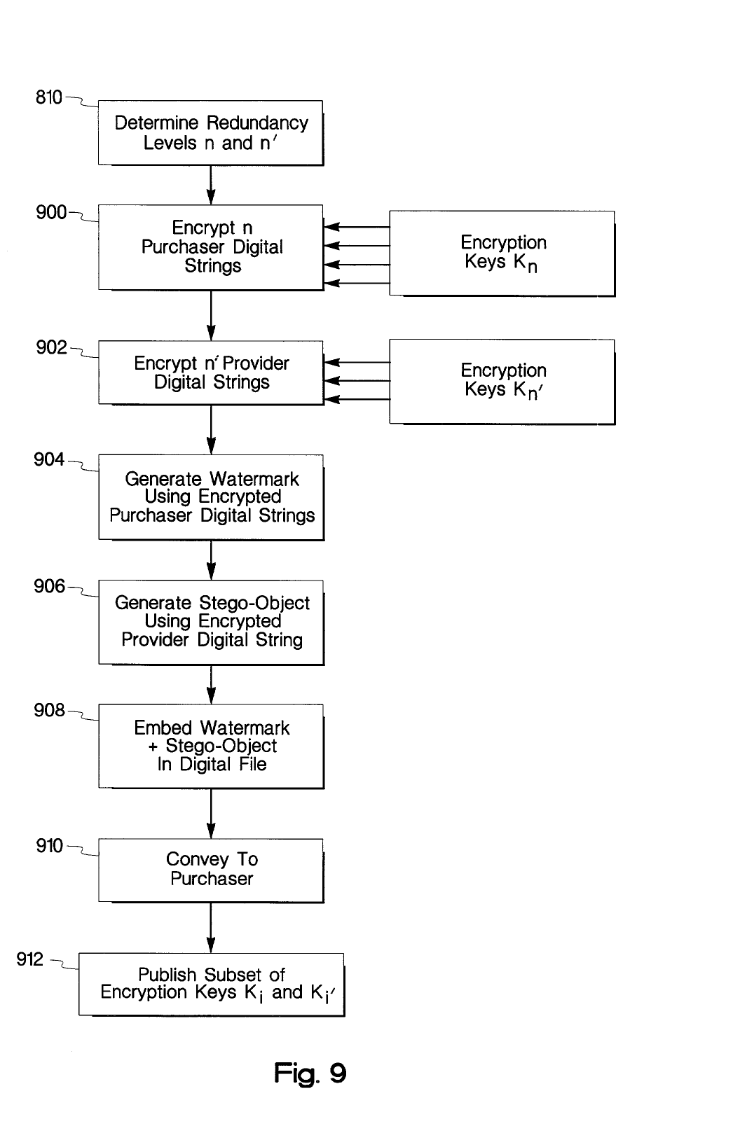

The operation of the present invention in a preferred embodiment using a combination of watermark and a steganographic technique is shown in the flow diagram of FIG. 9. Steps 800 through 810 are similar to those described in FIG. 8. In this embodiment, once the provider system, in step 810, determines the redundancy levels “n” and “n′”, the provider system, in step 900 encrypts “n” purchaser digital strings using the encryption keys K₁ through Kₙ. The provider system then, in step 902 encrypts “n′” provider digital strings using the encryption keys K₁ through K_{n′}. In step 904 the provider system generates a watermark using the encrypted purchaser digital strings from step 900. A steganographic object using the encrypted provider digital strings from step 902 is generated by the provider system in step 906. The watermark and stego-object formed in steps 904 and 906 are then embedded in the digital file, in step 908, forming the valued content. The valued content generated in step 908 is then conveyed to the purchaser in step 910. Preferably, the valued content is conveyed, in step 910, to the purchaser by transmitting the valued digital content over the Internet. However, It may also involve providing the valued content recorded on a portable media such as a DVD, or DAT either through a point of purchase machine 774 as shown in FIG. 7 or other means. The provider system also in step 912 publishes a subset of the encryption keys Kᵢ and K_{i′} used in steps 900 and 902 respectively to provide access to the purchaser's digital string in the event that the purchaser unlawfully distributes the valued content to others.

Thus, a content provider's need to cripple or hinder output devices such as DVD players, printers, digital audio tape players etc. in some fashion when improperly obtained (i.e. pirated) content is accessed, or their attempt to mark or label the valued content with some ownership information in order for the owner to then legally attempt to enforce his rights against those who have improperly distributed or obtained the valued content is alleviated. The compromises the content provider typically makes between robustness of the protection system and some other attribute either of the digital file being protected or the information being embedded is reduced.

A feature of the present invention, unlike the prior techniques used by the owner to actively protect his rights includes the embedding of information, which has a latent value to the purchaser, in the digital file before that file is used by the purchaser. In this manner, the very ubiquity of pirating is an enforcement method by tying together the property rights of the content provider and the purchaser. In combining the interests of providers and purchasers by embedding information that the purchaser is unlikely to want to have distributed, the purchaser is converted into a guardian of the valued content. Thus, potential pirates are changed into enforcers. The present invention advantageously uses information obtained from each purchaser that has a latent value to the purchaser to embed in the digital content before the purchaser has access to the digital content.

What is claimed is:

1. Valued content in a digital form comprising:
a digital file; and
a digital string provided by a purchaser to a provider system of the valued content, having a latent value at least to said purchaser, and embedded in said digital file by said provider system before the valued content is conveyed to said purchaser.

2. Valued content in accordance with claim 1, wherein said embedded digital string further comprises an embedded digital string encrypted by said provider system.

3. Valued content in accordance with claim 2, wherein said encrypted digital string further comprises a private digital string encrypted using a public key of a private/public encryption key pair and a public digital string encrypted using a private key of said private/public key encryption key pair.

4. Valued content in accordance with claim 1, wherein the valued content further comprises said digital string embedded in said digital file in a human perceptible form.

5. Valued content in accordance with claim 1, wherein said digital file further comprises a digital watermark generated by said provider system from said digital string.

6. Valued content in accordance with claim 1, wherein said digital file further comprises a digitized image.

7. Valued content in accordance with claim 1, wherein said digital file further comprises text.

8. Valued content in accordance with claim 1, wherein said digital file further comprises video images.

9. Valued content in accordance with claim 1, wherein said digital file further comprises digitized audio.

10. Valued content in accordance with claim 1, wherein said latent value further comprises information which places said purchaser at increased financial risk when known by another.

11. Valued content in accordance with claim 1, wherein said digital file further comprises a provider digital string.

12. Valued content in accordance with claim 11, wherein said provider digital string further comprises a digital string encrypted by said provider system.

13. Valued content in accordance with claim 1, further comprising a portable media including said embedded digital file recorded on said portable media.

14. Valued content in accordance with claim 1, further comprising a portable media having said embedded digital file recorded thereon.

15. Valued content in a digital form comprising:
a digital file; and
a digital string provided by a purchaser to a provider system of the valued content, encrypted by said provider system, combined with an encrypted provider digital string, and embedded in said digital file by said provider system before the valued content is conveyed to said purchaser, said digital string having a latent value at least to said purchaser which places said purchaser at increased financial risk when known by another.

16. Valued content in a digital form comprising:
an encrypted digital file having a digital string embedding process therein;
an encryption key; and
a digital string provided by a purchaser system to a provider system, having a latent value at least to said purchaser, and is embedded in said encryption key by said provider system before said encryption key, is conveyed to said purchaser, whereby a purchaser system decrypts said encrypted digital file using said embedded encryption key.

17. Valued content in accordance with claim 16, wherein said purchaser system embeds said digital string into said decrypted digital file using said digital string embedding process forming the valued content.

18. Valued content in a digital form comprising:
an encrypted digital file having a digital string embedder;
an encryption key; and
a digital string provided by a purchaser system to a provider system, having a latent value at least to said purchaser, and embedded in said encryption key by said provider system forming an authorization file, which is to be conveyed to said purchaser system.

19. Valued content in accordance with claim 18, wherein said encrypted digital file further comprises an extractor wherein said extractor uses said authorization file to decrypt said encrypted digital file and said digital string embedder embeds said digital string into said decrypted digital file using said purchaser system forming the valued content.

20. Valued content in a digital form comprising:
an encrypted digital file;
an authorization file having
an encryption key;
a digital string provided by a purchaser system to a provider system, having a latent value at least to said purchaser, and embedded in said encryption key by said provider system; and
a digital string embedding process including the capability of:
conveying said authorization file to said purchaser system;
decrypting said encrypted digital file using said authorization file;
embedding said digital string into said decrypted digital file forming the valued content using both said authorization file and said digital string embedding process.

21. A method for protecting valued content comprising the steps of:
acquiring a digital string from a purchaser, said digital string having a latent value at least to said purchaser;
embedding said acquired digital string in a digital file; and
conveying said embedded digital string and said digital file, as valued content, to said purchaser.

22. A method in accordance with the method of claim 21, further comprising the step of encrypting said digital string.

23. A method in accordance with the method of claim 22, wherein said encrypting step further comprises the step of encrypting said digital string with a public encryption key of a private/public encryption key pair forming a private digital string.

24. A method in accordance with the method of claim 22, wherein said encrypting step further comprises the step of encrypting said digital string with a private encryption key of a private/public encryption key pair forming a public digital string.

25. A method in accordance with the method of claim 21, further comprising the step of generating a digital watermark from said digital string.

26. A method in accordance with the method of claim 21, wherein said embedding step further comprises the step of embedding a provider digital string in said digital file.

27. A method in accordance with the method of claim 26, further comprising the step of encrypting said provider digital string.

28. A method in accordance with the method of claim 21, further comprising the step of recording said embedded digital file on a portable media.

29. A method in accordance with the method of claim 21, wherein said conveying step further comprises the step of transmitting said valued content to said purchaser via a network.

30. A method in accordance with the method of claim 21, wherein said conveying step further comprises the step of transmitting said valued content to said purchaser via a wireless communication network.

31. A method in accordance with the method of claim 21, wherein said embedding step further comprises embedding said acquired digital string in a digitized image.

32. A method in accordance with the method of claim 21, wherein said embedding step further comprises embedding said acquired digital string in digitized audio.

33. A method in accordance with the method of claim 21, wherein said embedding step further comprises embedding said acquired digital string in a video image.

34. A method in accordance with the method of claim 21, wherein said acquiring step further comprises acquiring information from said purchaser that places said purchaser at increased financial risk when known by another.

35. A method in accordance with the method of claim 21, further comprising the step of a provider system negotiating with said purchaser system to determine a content for said digital string.

36. A method for protecting valued content comprising the steps of:
acquiring a digital string from a purchaser, said digital string having a latent value at least to said purchaser;
embedding said acquired digital string in an encryption key; and
conveying embedded encryption key and an encrypted digital file, as valued content, to said purchaser.

37. A system for generating valued content in a digital form comprising:
a processor;
a storage device coupled to said processor;
an interface coupled to said processor and a purchaser system; and
a valued content in a digital form comprising:
a digital file, and
a digital string provided by a purchaser to said processor, having a latent value at least to said purchaser, and embedded in said digital file by said processor forming a second digital file to be conveyed to said purchaser system as valued content system using said interface.

38. The system of claim 37, further comprising an output device coupled to said processor to provide human perception of said content.

39. The system of claim 37, further comprising:
an interface coupled to said processor; and
a network connection coupled to said interface and to a purchaser system.

40. The system of claim 39, further comprising a wireless network coupled to said interface and said purchaser system.

41. The system of claim 37, wherein said processor is adapted to negotiate with said purchaser system to determine a content of said digital string.

42. The system of claim 37, further comprising a point of sale machine coupled to said processor.

43. The system of claim 42, further comprising:
an interface coupled to said processor;
a sale interface coupled to said point of sale machine;
a network connection to said interface and to said sale interface.

44. A system for generating valued content in a digital form comprising:
a purchaser processor adapted to communicate to said provider system an interest in purchasing a digital file from a content owner;
an interface coupled to said purchaser processor and a provider system adapted to request a digital string from said purchaser processor, having a latent value at least to said purchaser; and
a storage device coupled to said purchaser processor and adapted to send said digital string to said provider processor using said interface.

45. The system of claim 44, further comprising a wireless network coupled to said interface and said provider system.

46. The system of claim 44, further comprising a network coupled to said interface and said provider system.
